(19) United States
(12) Patent Application Publication
(10) Pub. No.: US 2018/0001780 A1
(43) Pub. Date: Jan. 4, 2018

(54) MATRIX-TYPE FLEXIBLE CHARGING PILE AND A CHARGING METHOD CAPABLE OF DYNAMICALLY ALLOCATING POWER

(71) Applicant: SHENZHEN AUTO ELECTRIC POWER PLANT CO., LTD, Shenzhen (CN)

(72) Inventors: Zhigang Li, Shenzhen (CN); Xinhang Wan, Shenzhen (CN); Wenyong Zhang, Shenzhen (CN); Quan Jin, Shenzhen (CN)

(21) Appl. No.: 15/708,179

(22) Filed: Sep. 19, 2017

Related U.S. Application Data
(63) Continuation of application No. PCT/CN2016/074257, filed on Feb. 22, 2016.

(30) Foreign Application Priority Data
Mar. 20, 2015 (CN) 201510124712.9

(51) Int. Cl. B60L 11/18; H01M 10/44

(52) U.S. Cl. CPC B60L 11/1844; H01M 10/44; B60L 11/1824; B60L 11/1848; H01M 2220/20

(57) ABSTRACT

A matrix-type flexible charging pile and a charging method capable of dynamically allocating power are disclosed in the present invention, and the method comprises the steps of: S1, connecting each charging terminal to a corresponding electric vehicle; S2, receiving a charging power demand of the electric vehicle and comparing the charging power demand; S3, calculating the number of charging modules required to be additionally allocated to the present DC-bus and delivering it to a matrix controller; and S4, allocating the required number of charging modules in a dynamic power region to the corresponding DC bus and switching the module communication line to a corresponding communication bus synchronously. The implementation of the charging method capable of dynamically allocating power can satisfy the electric vehicle charging demands for different energy storage capacities and different charging rates, as well as improve the conversion efficiency and the utilization rate of the charging device further.

### CROSS REFERENCE TO RELATED APPLICATIONS

The present application is a Continuation Application of PCT Application No. PCT/CN2016/074257 filed on Feb. 22, 2016, which claims the benefit of Chinese Patent Application No. 201510124712.9 filed on Mar. 20, 2015. All the above are hereby incorporated by reference.

### FIELD OF THE INVENTION

The present invention relates to the field of charging technology, and more particularly to a matrix-type flexible charging pile and a charging method capable of dynamically allocating power.

### BACKGROUND OF THE INVENTION

At present, various electric vehicles vary in energy storage battery capacity and charging rate, and have wide different requirements for the output power of the charger, and the output power of the charger is designed to be large so as to meet the charging demands of various electric vehicles in the community, which will cause a waste of charge capacity and a low utilization of the charger when charging the electric vehicle with a small energy storage capacity; although it can improve the utilization of the charger if the output power of the charger is designed to be small, it will prolong the charging time and cause the vehicle owner inconvenience when charging the electric vehicle with a large energy storage capacity. Also, with the rapid development of power battery technology, the demands of the electric vehicles for the power of the charging system in the future are becoming ever greater, and how to accommodate the future high-power charging demands using the existing charging facilities in the case of an appropriate increase in investment has always been one of the confusion in the construction of the charging facilities in the industry.

FIG. 3 shows the schematic of the existing charger. All of the charging modules of the existing charger are under centralized control and in one-to-one correspondence with the charger terminal, although the output power can be dynamically adjusted according to the demand value of the electric vehicle, it cannot solve the contradiction between low utilization of the charging device when the demand power of the electric vehicle is too low and insufficient charging capability when the demand power of the electric vehicle is too high.

### SUMMARY OF THE INVENTION

The technical problem to be solved by the present invention is to provide a matrix-type flexible charging pile and a charging method capable of dynamically allocating power.

The technical scheme adopted by the invention for solving the technical problem thereof is to construct a charging method capable of dynamically allocating power, comprising the steps of:

S1, connecting each charging terminal to a corresponding electric vehicle;

S2, receiving, by the charging terminal, a charging power demand of the electric vehicle and comparing the charging power demand with the module total power of a fixed power region corresponding to the charging terminal;

S3, calculating, by the charging terminal, the number of charging modules required to be additionally allocated to the present DC bus and delivering it to a matrix controller if the charging power demand exceeds the module total power of the fixed power region;

S4, allocating, by the matrix controller, the required number of charging modules in a dynamic power region to the corresponding DC bus according to the number of charging modules that required, and switching the module communication line to a corresponding communication bus synchronously.

In the charging method capable of dynamically allocating power of the present invention, the step S3 also comprises the steps of:

S3-1, deactivating the matrix controller if the charging power demand does not exceed the module total power of the fixed power region.

In the charging method capable of dynamically allocating power of the present invention, also comprising the steps of:

S5, realistically receiving, by the charging terminal, a demand information of the electric vehicle and automatically adjusting an output voltage current value of each charging module on the DC bus and adjusting it according to a detected actual output feedback value;

S6, recalculating, by the charging terminal, the number of charging modules required to be added and delivering it to the matrix controller, when the charging terminal detects that the demand value of the electric vehicle is increased.

S7, allocating, by the matrix controller, the required number of charging modules to be added to the corresponding DC bus according to the number of charging modules allocatable in the dynamic power region and feeding back the information to the charging terminal.

In the charging method capable of dynamically allocating power of the present invention, the step S6 also comprises the steps of:

S6-1, calculating, by the charging terminal, the number of charging modules that can exit and delivering it to the matrix controller, when the charging terminal detects that the demand value of the electric vehicle is decreased;

S6-2, controlling, by the matrix controller, the corresponding number of charging modules to exit, wherein the exited charging module automatically returns to a power dynamically allocatable state.

In the charging method capable of dynamically allocating power of the present invention, also comprising the steps of:

S8, instructing, by the charging terminal, the matrix controller to exit all of the charging modules allocated to the present DC bus in the dynamic power region after the charging terminal detects that the charging is completed.

In the charging method capable of dynamically allocating power of the present invention, all of the charging modules in the dynamic power region are electrically connected with the corresponding DC buses of the charging terminals through a dynamic allocation array;

The matrix controller controls each controllable switch in the dynamic allocation array, respectively.

The invention also constructs a matrix-type flexible charging pile, comprising:

A charging terminal for receiving a charging demand value delivered by an electric vehicle and calculating the number of charging modules that required, instructing a matrix controller to perform power allocation and dynamically adjusting the actual output voltage and current according to the demand of the electric vehicle;

A fixed power region comprising charging modules that do not participate in the power dynamic allocation, wherein the charging module is fixedly connected to a corresponding charging terminal for satisfying a basic charging function of the charging terminal;

A dynamic power region comprising charging modules that participate in the power dynamic allocation, and dynamic allocation arrays, wherein the charging module is allocated to a DC bus corresponding to the charging terminal through the dynamic allocation array;

A matrix controller connected with the charging terminal in communication for receiving a demand information of the charging terminal and providing a corresponding number of charging modules according to the demand information and controlling the required number of charging modules in the dynamic power region to be switched to the DC buses corresponding to the charging modules, and shutting the charging modules from being switched to the other DC buses.

The matrix-type flexible charging pile of the invention also comprises:

A dynamic allocation array for electrically connecting all of the charging modules in the dynamic power region with the DC buses of the corresponding charging terminals.

In the matrix-type flexible charging pile of the invention, the dynamic allocation array is comprised of controllable switching devices; the controllable switching device comprises a plurality of high voltage DC contactors;

Each controllable switching device in the dynamic allocation array is controlled by the matrix controller.

The matrix-type flexible charging pile of the invention also comprises:

A protector for preventing a safety accident caused by malfunction or failure of the controllable switching device in the dynamic allocation array;

The protector comprises a DC diode provided on the DC output side of each of the charging terminals, and the DC diode is mounted on the DC+end and/or is reversely mounted on the DC-end.

The implementation of the technical scheme of the present invention has at least the following advantageous: adopting the charging method capable of dynamically allocating power can automatically provide different power from the dynamic power region according to the actual demands of different types of electric vehicles, which satisfies the electric vehicle charging demands for different energy storage capacities and different charging rates, as well as improves the conversion efficiency and the utilization rate of the charging device further.

### BRIEF DESCRIPTION OF THE DRAWINGS

The invention will hereinafter be described further in conjunction with the accompanying drawings and the embodiments, in the drawings:

FIG. 1 is a flow diagram illustrating a charging method capable of allocating power, in accordance with an embodiment of the present invention;

FIG. 2 is a flow diagram illustrating a charging method capable of allocating power, in accordance with another embodiment of the present invention;

FIG. 3 is a schematic diagram illustrating a charger of a conventional electric vehicle;

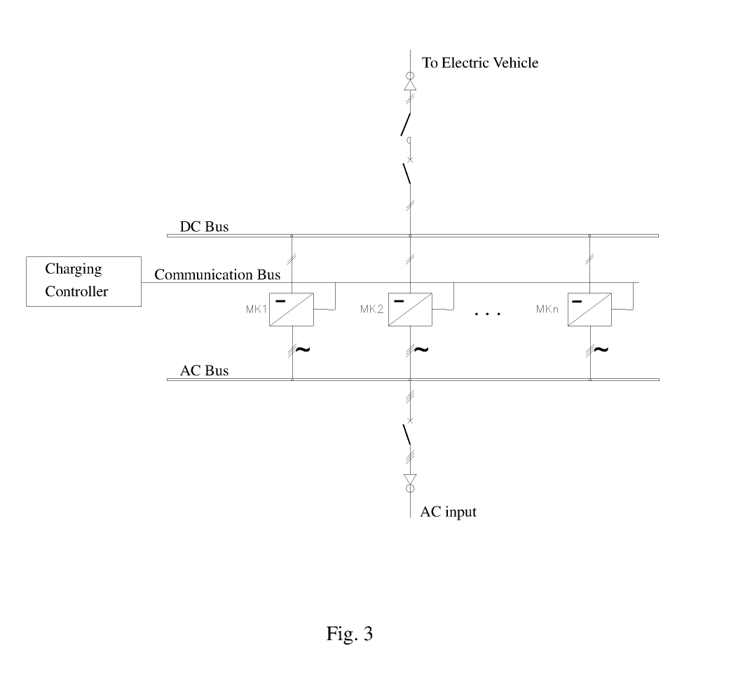

FIG. 4 is a schematic diagram illustrating a main circuit control of a matrix-type flexible charging pile, in accordance with an embodiment of the present invention;

FIG. 5 is a schematic diagram illustrating a communication circuit control of a matrix-type flexible charging pile, in accordance with an embodiment of the present invention;

FIG. 6 is a schematic diagram illustrating a main circuit control of a matrix-type flexible charging pile, in accordance with another embodiment of the present invention;

### DETAILED DESCRIPTION OF THE EMBODIMENTS

The embodiments of the present invention will now be described in detail with reference to the accompanying drawings to provide a clearer understanding of the technical features, objects and effects of the present invention.

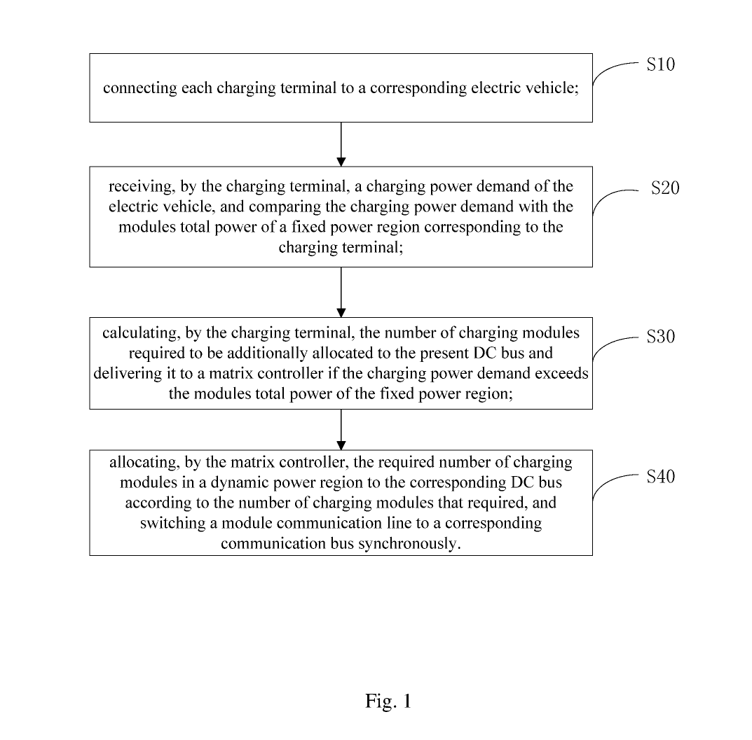

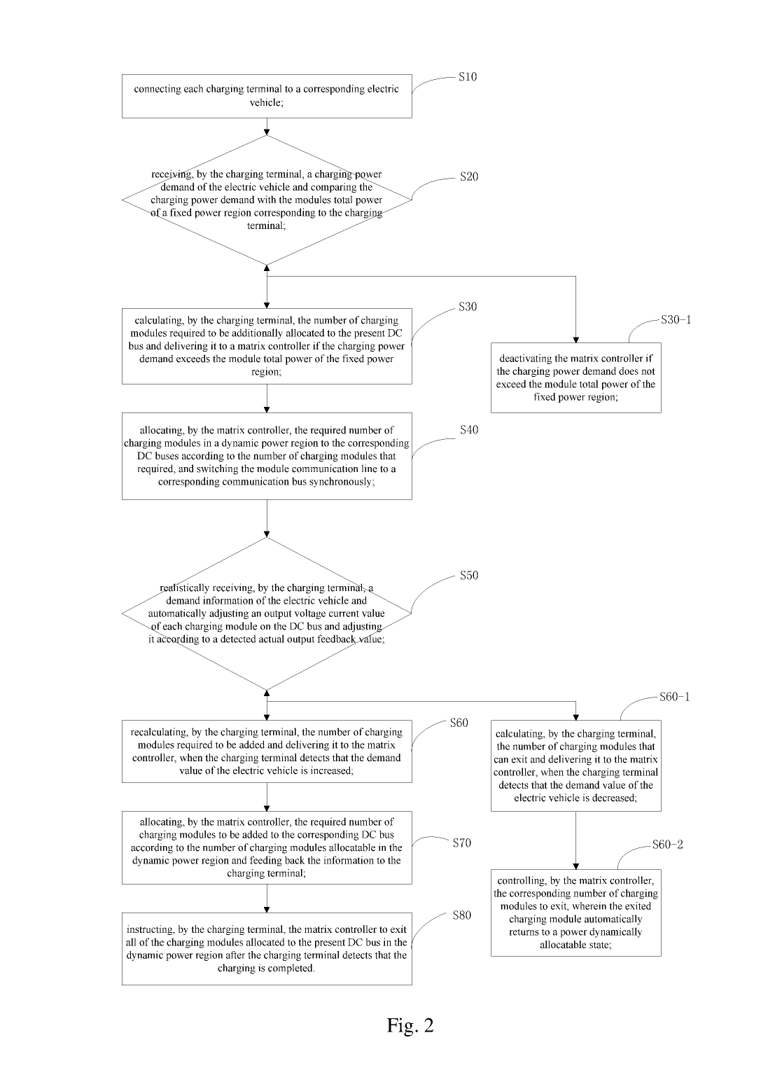

FIGS. 1 to 2 show a charging method capable of dynamically allocating power in the present invention which can automatically provide different power from the dynamic power region according to the actual demands of different types of electric vehicles, thereby satisfy the electric vehicle charging demands for different energy storage capacities and different charging rates, as well as improve the conversion efficiency and the utilization rate of the charging device further.

As shown in FIG. 1, the charging method capable of dynamically allocating power comprises the steps of:

S10, connecting each charging terminal to a corresponding electric vehicle;

S20, receiving, by the charging terminal, a charging power demand of the electric vehicle and comparing the charging power demand with the modules total power of a fixed power region corresponding to the charging terminal;

S30, calculating, by the charging terminal, the number of charging modules required to be additionally allocated to the present DC bus and delivering it to a matrix controller if the charging power demand exceeds the module total power of the fixed power region;

S40, allocating, by the matrix controller, the required number of charging modules in a dynamic power region to the corresponding DC bus according to the number of charging modules that required, and switching the module communication line to a corresponding communication bus synchronously.

As shown in FIG. 2, in some embodiments, the charging method capable of dynamically allocating power also comprises the steps of:

S10, connecting each charging terminal to a corresponding electric vehicle;

S20, receiving, by the charging terminal, a charging power demand of the electric vehicle and comparing the charging power demand with the modules total power of a fixed power region corresponding to the charging terminal;

S30, calculating, by the charging terminal, the number of charging modules required to be additionally allocated to the present DC bus and delivering it to a matrix controller if the charging power demand exceeds the module total power of the fixed power region;

S40, allocating, by the matrix controller, the required number of charging modules in a dynamic power region to the corresponding DC bus according to the number of charging modules that required, and switching the module communication line to a corresponding communication bus synchronously;

S50, realistically receiving, by the charging terminal, a demand information of the electric vehicle and automatically adjusting an output voltage current value of each charging module on the DC bus and adjusting it according to a detected actual output feedback value;

S60, recalculating, by the charging terminal, the number of charging modules required to be added and delivering it to the matrix controller, when the charging terminal detects that the demand value of the electric vehicle is increased.

S70, allocating, by the matrix controller, the required number of charging modules to be added to the corresponding DC bus according to the number of charging modules allocatable in the dynamic power region and feeding back the information to the charging terminal.

S80, instructing, by the charging terminal, the matrix controller to exit all of the charging modules allocated to the present DC bus in the dynamic power region after the charging terminal detects that the charging is completed.

Wherein, the step S30 also comprises the steps of:

S30-1, deactivating the matrix controller if the charging power demand does not exceed the module total power of the fixed power region.

The step S60 also comprises the steps of:

S60-1, calculating, by the charging terminal, the number of charging modules that can exit and delivering it to the matrix controller, when the charging terminal detects that the demand value of the electric vehicle is decreased;

S60-2, controlling, by the matrix controller, the corresponding number of charging modules to exit, wherein the exited charging module automatically returns to a power dynamically allocatable state.

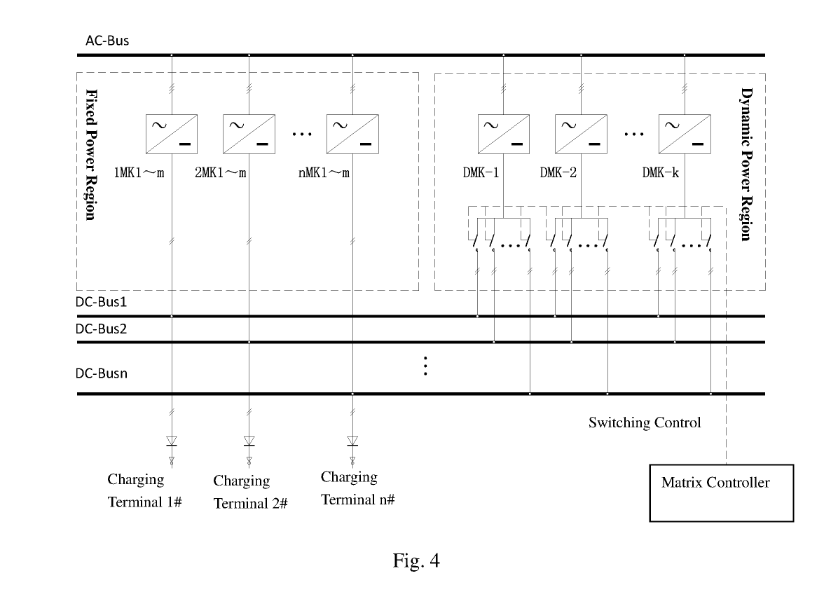

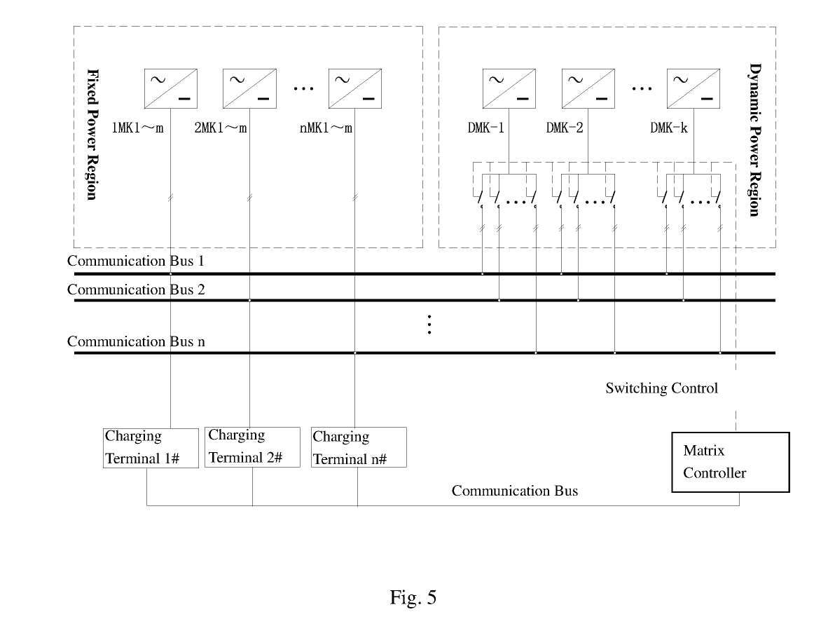

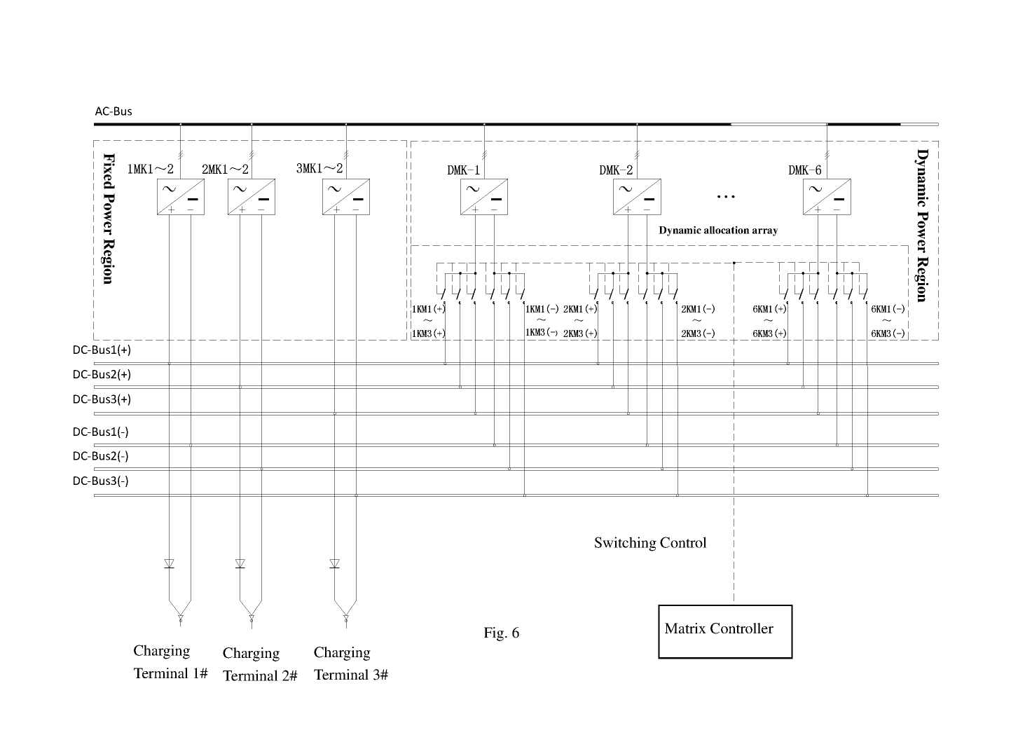

FIGS. 4 to 6 also show a matrix-type flexible charging pile in the present invention, which can automatically extract different powers from the “charging piles” according to the actual demands of different types of electric vehicles, and satisfy the electric vehicle charging demands for different energy storage capacities and different charging rates, as well as improve the conversion efficiency and the utilization rate of the charging device further, and solve the confusion in the industry that the charging facilities cannot be constructed until the target vehicle is determined, and avoid the repeated construction waste brought about by the progress of the battery technology.

The matrix-type flexible charging pile comprises:

A charging terminal for receiving a charging demand value delivered by an electric vehicle and calculating the number of charging modules that required, instructing a matrix controller to perform power allocation and dynamically adjusting the actual output voltage and current according to the demand of the electric vehicle;

A fixed power region being comprised of charging modules that do not participate in the power dynamic allocation, wherein the charging module is fixedly connected to the corresponding charging terminal for satisfying a basic charging function of the charging terminal;

A dynamic power region being comprised of charging modules that participate in the power dynamic allocation, and dynamic allocation arrays, wherein the charging module is allocated to a DC bus corresponding to the charging terminal through the dynamic allocation array to realize the dynamic allocation of the charging power;

A matrix controller connected with the charging terminal in communication for receiving a demand information of the charging terminal and providing a corresponding number of charging modules according to the demand information and controlling the required number of charging modules in the dynamic power region to be switched to the DC buses corresponding to the charging modules, and shutting the charging modules from being switched to the other DC buses.

In some embodiments, the matrix-type flexible charging pile also comprises:

A dynamic allocation array for electrically connecting all of the charging modules in the dynamic power region with the DC buses of the corresponding charging terminals.

Further, the dynamic allocation array is comprised of controllable switching devices; the controllable switching device comprises a plurality of high voltage DC contactors; and each controllable switching device in the dynamic allocation array is controlled by the matrix controller.

In some embodiments, the matrix-type flexible charging pile also comprises:

A protector for preventing a safety accident caused by malfunction or failure of the controllable switching device in the dynamic allocation array;

The protector comprises a DC diode provided on the DC output side of each of the charging terminals, and the DC diode is mounted on the DC+end and/or is reversely mounted on the DC-end.

Specifically, the specific features of the technical scheme of the present invention are as follows: three charging terminals are taken as an example with reference to FIGS. 4 to 6:

\textcircled{1} Fixed power region: the fixed power region has the minimal number of modules required for satisfying a basic charging function of the charging terminal, and the module is fixedly connected to a DC bus of the corresponding charging terminal, and the modules in the region do not have the function of power dynamic allocation. In the embodiment, 1MK1˜m, 2MK1˜m and 3MK1˜m are connected to the DC bus 1, DC bus 2 and DC bus 3 corresponding to the charging terminal 1#, 2# and 3#, respectively. Wherein, the number of modules of the fixed power region corresponding to the different terminals may be different. Take the three terminals corresponding to two 15 kW charging modules of the fixed power region as an example.

\textcircled{2} Dynamic power region: the dynamic power region is the main part for realizing the power dynamic allocation, and the modules in the region may be switched to the DC buses corresponding to the different terminals through the dynamic allocation arrays to realize the power dynamic allocation; take the dynamic power region configured with 6 sets of 15 kW charging modules recorded as DMK-1˜DMK6 respectively as an example.

\textcircled{3} Dynamic allocation array: it is mainly comprised of controllable switching devices, and is the actuating mechanism for switching the modules of the dynamic power region to the DC buses corresponding to the different terminals. In the example, high voltage DC contactors are selected as the controllable switching devices, and each charging module in the dynamic power region is configured with 6 DC contactors respectively, and the charging module outputs (+) are allocated to the DC bus 1 (+), DC bus 2 (+) and DC bus 3 (+) respectively, the charging module outputs (−) are allocated to DC bus 1 (−), DC bus 2 (−) and DC bus 3 (−) respectively, and the two contactors allocated to the same section of the DC bus operate synchronously.

\textcircled{4} Matrix controller: it is mainly used for receiving the number of charging modules required by the charging terminal and controlling the dynamic allocation array to switch the required number of modules to the DC buses corresponding to the charging terminal, and meanwhile shutting the modules from being switched to the other DC buses. It is mainly comprised of the control unit such as DSP, single-chip or PLC, etc. and communicates with the charging terminal through communication bus such as RS485, CAN, and controls the merge-joint of the DC contactors of the dynamic allocation array through the relay contact.

\textcircled{5} Charging terminal: it is the interactive interface between the charging pile and the electric vehicle, and it receives the charging demand value delivered by the electric vehicle and calculates the number of charging modules that required, instructs the matrix controller to perform power allocation and dynamically adjusts the actual output voltage and current according to the demand of the electric vehicle; in the example, the charging terminal performing digital communication with electric vehicle, matrix controller and charging module respectively is comprised of charging controller, human-machine interface, measuring and control device, charging interface, etc.

Additionally, in the embodiments shown in FIGS. 4 to 6, the number of charging terminals is 3, and the number of the corresponding DC buses is 3. The number of charging modules of the fixed power region corresponding to each terminal is 2, the number of modules of the dynamic power region is 6, and the rated power of a single charging module is 15 kW.

When each charging terminal is in an idle state, all of the charging modules are in holding state, and each high voltage DC contactor of the dynamic allocation array is in disconnect state, that is “all of the charging modules of the dynamic power region are disconnected from the respective DC buses”, and when the charging terminal 2# is connected with the electric vehicle and the received charging power demand value is 84kW (or voltage value, current value), the charging terminal will calculate that the number of charging modules required to be additionally allocated to the present DC bus is 4 (the total number of charging modules required is 6), and deliver it to the matrix controller. The matrix controller automatically controls the 1KM2 (+), 2KM2 (+), 3KM2 (+) and 4KM2 (+) in the dynamic allocation array to be allocated to the DC bus 2 (+) and 1KM2(−), 2KM2(−), 3KM2(−) and 4KM2(−) to the DC bus 2 (−), and switches the module communication line to the corresponding communication bus synchronously;

The charging terminal 2# will realistically receive the demand information of the electric vehicle and automatically adjust the output power value of each charging module on the present DC bus to 14 kW (or voltage current value) and adjust it according to the detected actual output feedback value; if the demand value of the electric vehicle is adjusted to 78 kW, the charging terminal will automatically limit the output power of each module to 13 kW. In the charging process, if the demand value of the electric vehicle is increased to 98 kW, the terminal will recalculate that the number of modules required to be added is 1, and instruct the matrix controller to control the 5 KM2 (+) and 5 KM2 (−) in the dynamic allocation array to be allocated to the DC bus 2 (+) and the DC bus 2 (−) respectively, and the charging terminal will adjust the output power of each module to 14 kW. It is similar when the charging demand value is decreased.

If the charging terminal 3# is connected with the electric vehicle in the charging process of the charging terminal 2#, the charging is activated. If the charging demand value delivered by the electric vehicle is 24 kW, no operation by the matrix controller is required, and the vehicle is charged with two charging modules of the fixed power region directly, and the charging terminal 3# controls the output power of each module to be 12 kW. If the charging demand value of the electric vehicle is 33 kW, the 6KM3 (+) and the 6KM3 (−) are allocated to the DC bus 3 (+) and the DC bus 3(−) respectively according to the steps described above, the charging terminal 3# will automatically adjust the output power of each charging module to 11 kW. If the charging demand value of the electric vehicle is 56 kW, the matrix controller will no longer operate since all of the modules in the dynamic power region have been allocated, charging terminal 3# will automatically adjust the output power of each charging module to 15kW. If some charging modules of the charging terminal 2# exit in the charging process of the charging terminal 3#, the matrix controller will inform the charging terminal 3# which then will recalculate the number of charging modules required to be additionally allocated and instruct the matrix controller to control the allocation of the corresponding modules.

The charging terminal 2# instructs the matrix controller to exit all of the charging modules of the dynamic power region allocated to the present DC bus, after the completion of the charging of the charging terminal 2#. At this point, the corresponding controllable switches in the dynamic allocation array are in disconnect state. It is similar for other terminals.

What described above are merely preferred embodiments of the present invention but are not used for limitation, and it will be understood by those skilled in the art that various modifications, combination and variations are possible for the present invention. Any modification, equivalent substitution or improvement, etc. within the spirit and principle of the present invention shall be included in the scope of claims of the present invention.

What is claimed is:

1. A charging method capable of dynamically allocating power, comprising the steps of:
S1, connecting each charging terminal to a corresponding electric vehicle;
S2, receiving, by the charging terminal, a charging power demand of the electric vehicle and comparing the charging power demand with the modules total power of a fixed power region corresponding to the charging terminal;
S3, calculating, by the charging terminal, the number of charging modules required to be additionally allocated to the present DC bus and delivering it to a matrix controller if the charging power demand exceeds the modules total power of the fixed power region;
S4, allocating, by the matrix controller, the required number of charging modules in a dynamic power region to the corresponding DC bus according to the number of charging modules that required, and switching a module communication line to a corresponding communication bus synchronously.

2. The charging method capable of dynamically allocating power of claim 1, wherein the step S3 also comprises the steps of:
S3-1, deactivating the matrix controller if the charging power demand does not exceed the module total power of the fixed power region.

3. The charging method capable of dynamically allocating power of claim 2, also comprising the steps of:
S5, realistically receiving, by the charging terminal, a demand information of the electric vehicle and automatically adjusting an output voltage current value of each charging module on the DC bus and adjusting it according to a detected actual output feedback value;
S6, recalculating, by the charging terminal, the number of charging modules required to be added and delivering it to the matrix controller, when the charging terminal detects that the demand value of the electric vehicle is increased.
S7, allocating, by the matrix controller, the required number of charging modules to be added to the corresponding DC bus according to the number of charging modules allocatable in the dynamic power region and feeding back the information to the charging terminal.

4. The charging method capable of dynamically allocating power of claim 3, wherein the step S6 also comprises the steps of:
S6-1, calculating, by the charging terminal, the number of charging modules that can exit and delivering it to the matrix controller, when the charging terminal detects that the demand value of the electric vehicle is decreased;
S6-2, controlling, by the matrix controller, the corresponding number of charging modules to exit, wherein the exited charging module automatically returns to a power dynamically allocatable state.

5. The charging method capable of dynamically allocating power of claim 4, also comprising the steps of:
S8, instructing, by the charging terminal, the matrix controller to exit all of the charging modules allocated to the present DC bus in the dynamic power region after the charging terminal detects that the charging is completed.

6. A charging method capable of dynamically allocating power claim 1, wherein all of the charging modules in the dynamic power region are electrically connected with the corresponding DC buses of the charging terminals through a dynamic allocation array;
the matrix controller controls each controllable switch in the dynamic allocation array, respectively.

7. A charging method capable of dynamically allocating power claim 2, wherein all of the charging modules in the dynamic power region are electrically connected with the corresponding DC buses of the charging terminals through a dynamic allocation array;
the matrix controller controls each controllable switch in the dynamic allocation array, respectively.

8. A charging method capable of dynamically allocating power claim 3, wherein all of the charging modules in the dynamic power region are electrically connected with the corresponding DC buses of the charging terminals through a dynamic allocation array;
the matrix controller controls each controllable switch in the dynamic allocation array, respectively.

9. A charging method capable of dynamically allocating power claim 4, wherein all of the charging modules in the dynamic power region are electrically connected with the corresponding DC buses of the charging terminals through a dynamic allocation array;
the matrix controller controls each controllable switch in the dynamic allocation array, respectively.

10. A charging method capable of dynamically allocating power claim 5, wherein all of the charging modules in the dynamic power region are electrically connected with the corresponding DC buses of the charging terminals through a dynamic allocation array;
the matrix controller controls each controllable switch in the dynamic allocation array, respectively.

11. A matrix-type flexible charging pile, comprising:
a charging terminal for receiving a charging demand value delivered by an electric vehicle and calculating the number of charging modules that required, instructing a matrix controller to perform power allocation and dynamically adjusting the actual output voltage and current according to the demand of the electric vehicle;
a fixed power region comprising charging modules that do not participate in the power dynamic allocation, wherein the charging module is fixedly connected to a corresponding charging terminal for satisfying a basic charging function of the charging terminal;
a dynamic power region comprising charging modules that participate in the power dynamic allocation, and dynamic allocation arrays, wherein the charging module is allocated to a DC bus corresponding to the charging terminal through the dynamic allocation array;
a matrix controller connected with the charging terminal in communication for receiving a demand information of the charging terminal and providing a corresponding number of charging modules according to the demand information and controlling the required number of charging modules in the dynamic power region to be switched to the DC buses corresponding to the charging modules, and shutting the charging modules from being switched to the other DC buses.

12. The matrix-type flexible charging pile of claim 11, also comprising:
the dynamic allocation array for electrically connecting all of the charging modules in the dynamic power region with the DC buses of the corresponding charging terminals.

13. The matrix-type flexible charging pile of claim 11, wherein the dynamic allocation array is comprised of controllable switching devices; the controllable switching device comprises a plurality of high voltage DC contactors;
each controllable switching device in the dynamic allocation array is controlled by the matrix controller.

14. The matrix-type flexible charging pile of claim 13, also comprising:
a protector for preventing a safety accident caused by malfunction or failure of the controllable switching device in the dynamic allocation array;
the protector comprises a DC diode provided on the DC output side of each of the charging terminals, and the DC diode is mounted on the DC+end and/or is reversely mounted on the DC-end.
